(19) United States
(12) Patent Application Publication
(10) Pub. No.: US 2024/0165723 A1
(43) Pub. Date: May 23, 2024

(54) CUTTING BLADE

(71) Applicant: MILWAUKEE ELECTRIC TOOL CORPORATION, Brookfield, WI (US)

(72) Inventors: Timothy M. Whitty, Kenosha, WI (US); Austin J. Kazda, Wauwatosa, WI (US); Geoffrey R. Piller, Grafton, WI (US)

(21) Appl. No.: 18/551,637

(22) PCT Filed: Apr. 12, 2022
(86) PCT No.: PCT/US2022/024387

§ 371 Date: Sep. 21, 2023

Related U.S. Application Data
(60) Provisional application No. 63/173,552, filed on Apr. 12, 2021.

(51) Int. Cl. B23D 61/12; B23D 61/00

(52) U.S. Cl. CPC B23D 61/121; B23D 61/006; B23D 61/123

(57) ABSTRACT

A cutting blade includes a body defining a longitudinal axis, an attachment portion coupled to the body, the attachment portion configured to be coupled to a power tool, and a cutting portion extending along an edge of the body parallel to the longitudinal axis, the cutting portion including a plurality of cutting teeth. Each cutting tooth includes a tip and a rake face extending from the tip, and each cutting tooth also includes a carbide insert that forms at least the tip of the cutting tooth. At least part of the cutting portion is deflectable relative to the body.

### CROSS-REFERENCE TO RELATED APPLICATIONS

This application claims priority to U.S. Provisional Patent Application No. 63/173,552, filed Apr. 12, 2021, the entire contents of which are incorporated herein by reference.

### FIELD

The present invention relates to cutting blades for use with a power tool and, more particularly, to shock absorbing elements on cutting blades.

### BACKGROUND

Cutting blades, such as reciprocating saw blades, oscillating multi tool (OMT) blades, or the like are used for cutting wood, metal, plastics, and other materials. A cutting blade typically includes a body, one or more attachment portions, and a cutting portion. The cutting portion traditionally includes a plurality of teeth made up of one or more tooth forms. Tooth forms on cutting blades are a major factor in the durability, cost, speed of cutting, and accuracy and quality of cuts made.

### SUMMARY

In one embodiment, the invention provides a cutting blade including a body defining a longitudinal axis, an attachment portion coupled to the body, the attachment portion configured to be coupled to a power tool, and a cutting portion extending along an edge of the body parallel to the longitudinal axis, the cutting portion including a plurality of cutting teeth, each cutting tooth including a tip and a rake face extending from the tip, each cutting tooth also including a carbide insert that forms at least the tip of the cutting tooth. At least part of the cutting portion is deflectable relative to the body.

In another embodiment, the invention provides a cutting blade including a body defining a longitudinal axis, an attachment portion coupled to the body, the attachment portion configured to be coupled to a power tool, a plurality of cutting teeth extending from a portion of the body, the plurality of cutting teeth defining a cutting edge of the cutting blade, an aperture extending in a direction principally parallel to the longitudinal axis, the aperture including a first end adjacent a first cutting tooth and a second end adjacent a second cutting tooth axially offset from the first cutting tooth, the second end being closer than the first end to the attachment portion, and a cantilever portion formed between the aperture and the cutting edge, extending between the first end and the second end of the aperture, and supporting some of the cutting teeth, the cantilever portion being deflectable in a direction transverse relative to the longitudinal axis.

In still another embodiment, the invention provides a cutting blade including a body defining a longitudinal axis, an attachment portion coupled to the body, the attachment portion configured to be coupled to a power tool, and a cutting portion extending along an edge of the body, the cutting portion including a first plurality of cutting teeth defining a first plane extending parallel to the longitudinal axis, and a second plurality of cutting teeth axially offset from the first plurality of cutting teeth and defining a second plane, the second plurality of cutting teeth supported on a cantilever portion and configured to deflect relative to the first plurality of cutting teeth, during which the first plane and the second plane are misaligned. The cantilever portion has a base end and a free end, and the base end is closer than the free end to the attachment portion.

Other aspects of the invention will become apparent by consideration of the detailed description and accompanying drawings.

### BRIEF DESCRIPTION OF THE DRAWINGS

FIG. 1 is a perspective view of a cutting blade, according to one embodiment of the invention.

FIG. 2 is an enlarged side view of a portion of the cutting blade of FIG. 1.

FIG. 3 is the side view of FIG. 2, illustrating a portion of the cutting blade in a deflected position.

FIG. 4 is a side view of the cutting blade of FIG. 1.

FIG. 5 is a side view of the cutting blade of FIGS. 1-4, according to another example construction.

FIG. 6 is a side view of the cutting blade of FIGS. 1-4, according to another example construction.

FIG. 7 is a side view of the cutting blade of FIGS. 1-4, according to another example construction.

FIG. 8 is a side view of the cutting blade of FIGS. 1-4, according to another example construction.

FIG. 9 is a side view of the cutting blade of FIGS. 1-4, according to another example construction.

FIG. 10 is a side view of the cutting blade of FIGS. 1-4, according to another example construction.

FIG. 11 is a side view of the cutting blade of FIGS. 1-4, according to another example construction.

FIG. 12 is a side view of a cutting blade, according to another embodiment of the invention.

FIG. 13 is a side view of a cutting blade, according to another embodiment of the invention.

FIG. 14 is a side view of a cutting blade, according to another embodiment of the invention.

FIG. 15 is a side view of the cutting blade of FIG. 14, according to another example construction.

FIG. 16 is a side view of a cutting blade, according to another embodiment of the invention.

FIG. 17 is a side view of the cutting blade of FIG. 16, according to another example construction.

FIG. 18 is a side view of a cutting blade, according to another embodiment of the invention.

FIG. 19 is a side view of a cutting blade, according to another embodiment of the invention.

FIG. 20 is perspective view of a reciprocating saw.

FIG. 21 is perspective view of an oscillating multi tool.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

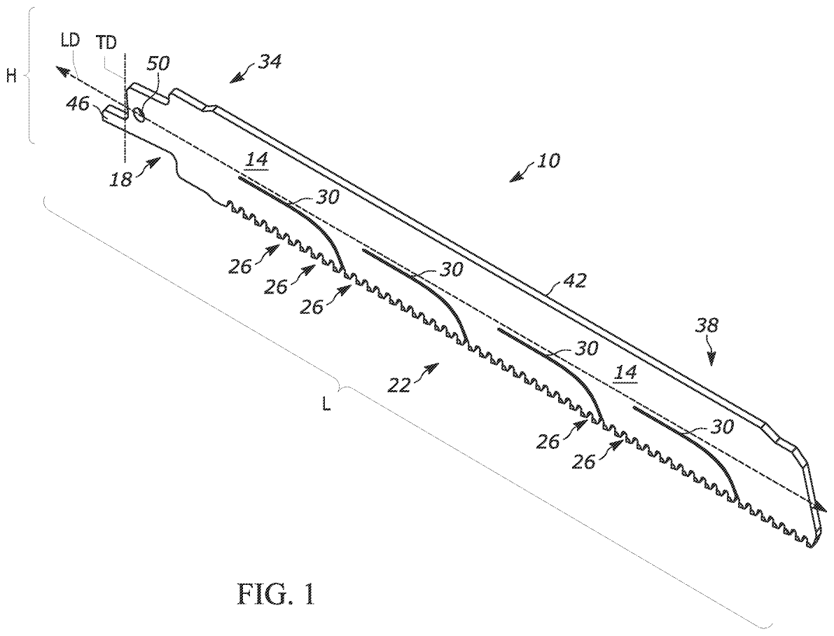

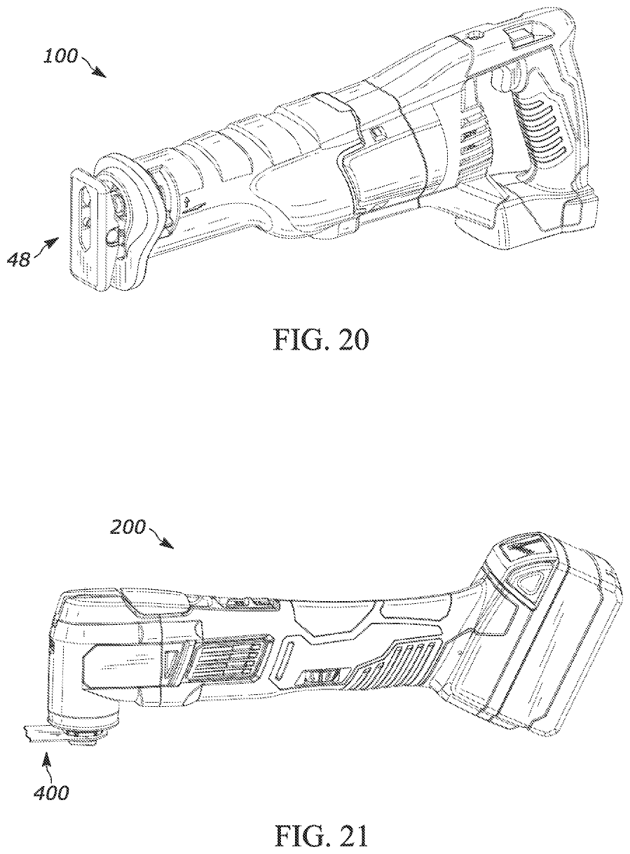

FIGS. 1-11 illustrate a cutting blade 10 according to one embodiment. The cutting blade 10 of FIGS. 1-11 is a saw blade, such as a reciprocating saw blade, for use with a power tool such as, for example, a reciprocating saw 100 (FIG. 20). The cutting blade 10 includes a body 14, an attachment portion 18 for coupling the cutting blade 10 to the reciprocating saw 100, a cutting portion 22 having a plurality of cutting teeth 26, and one or more apertures 30 formed in the body 14.

With reference to FIG. 1, an overall length L of the body 14 defines a longitudinal direction LD of the cutting blade 10, and an overall height H of the body 14 defines a transverse direction TD. During operation, the cutting blade 10 is reciprocated along the longitudinal direction LD in cutting and return directions to cut through a work piece. In some embodiments, the cutting blade 10 may be used to cut through work pieces composed of wood having nails extending through or embedded therein.

The body 14 may include a first end portion 34 and a second end portion 38 separated from the first end portion 34 along the longitudinal direction LD. The body 14 also defines a longitudinal axis extending through the first and second end portions 38. The longitudinal axis is parallel to the longitudinal direction LD. The body 14 may further include a back edge 42 separated from the cutting portion 22 along the transverse direction TD. Stated another way, the longitudinal direction LD extends through the first and second end portions 34, 38, and the transverse direction TD extends through the cutting portion 22 and the back edge 42. In some embodiments, the back edge 42 includes one or more sloped or ramped surfaces.

With continued reference to FIG. 1, the attachment portion 18 may extend from the first end portion 34 of the body 14. The attachment portion 18 is coupled to the body 14. In some embodiments, the attachment portion 18 is integrally formed as a single piece with the body 14. In other embodiments, the attachment portion 18 is a separate piece that is secured (e.g., welded) to the body 14. The attachment portion 18 includes a tang 46 and an aperture 50. The tang 46 and the aperture 50 are configured to engage a blade clamp 48 of the reciprocating saw 100 to securely and releasably couple the cutting blade 10 to the reciprocating saw 100. The attachment portion 18 may be angled relative to the longitudinal direction LD.

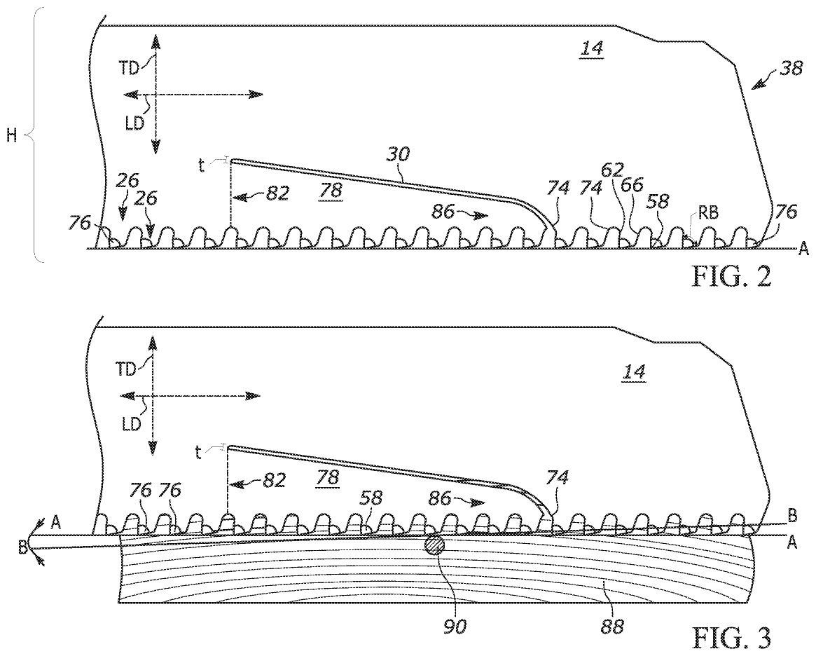

Referring now to FIGS. 2 and 3, the cutting teeth 26 are coupled to the body 14 to define the cutting portion 22. The cutting teeth 26 define a tooth form 54 of the cutting blade 10. In the illustrated embodiment, the cutting teeth 26 are integrally formed as a single piece with the body 14. In other embodiments, the cutting portion 22 and the cutting teeth 26 may be a separate strip of metal that is secured (e.g., welded) to the body 14 creating, for example, a bi-metal blade. The cutting teeth 26 form a linear cutting edge on the body 14. In the illustrated embodiment, all of the cutting teeth 26 are generally the same shape and size. In other embodiments, the cutting teeth 26 may have different shapes or sizes relative to each other. Additionally, the cutting teeth 26 may be arranged in repeating patterns of different shapes and sizes. Each cutting tooth 26 includes a tip 58, a rake face 62 extending from the tip 58, a heel face 66 opposite the rake face 62, and a relief surface 70 extending between the tip 58 and the heel face 66. The relief surface 70 may extend between the tip 58 and the heel face 66 at an oblique angle relative the longitudinal axis. A gullet 74 is formed between the rake face 62 of one cutting tooth 26 and the heel face 66 of an adjacent cutting tooth 26. In other words, the gullets 74 may separate adjacent cutting teeth 26. In some embodiments, at least some of the cutting teeth 26 may be set (e.g., bent) relative to the body 14.

As best illustrated in FIGS. 2 and 3, each of the illustrated cutting teeth 26 also includes a carbide insert 76. The carbide inserts 76 form part of the cutting teeth 26. For example, each carbide insert 76 may form the tip 58, part of the rake face 62, and part of the relief surface 70. The carbide inserts 76 may be welded or otherwise secured to the rest of a material making up the cutting teeth 26. In some embodiments, only some of the cutting teeth 26 may include a carbide insert 76. In other embodiments, the cutting teeth 26 may not include carbide inserts.

As best shown in FIG. 2, the tips 58 of the cutting teeth 26 define a plane A-A that extends along a direction generally parallel relative the longitudinal direction LD and the longitudinal axis. The plane A-A may also be considered a cutting plane along which the cutting teeth 26 contact a workpiece 88 (FIG. 3). Each rake face 62 extends from the corresponding tip 58 at a rake angle RB relative to the plane A-A. The illustrated rake angles RB are less than 90 degrees relative to the plane A-A. In some embodiments, the rake angles RB may be greater than 90 degrees relative to the plane A-A. In other embodiments, the rake angle RB may vary along the cutting portion 22.

Referring now to FIGS. 1-4, the cutting blade 10 includes one or more of the apertures 30 formed in the body 14. In the illustrated embodiment, the apertures 30 are elongated and may include a slot or slot profile. Each aperture 30 may form a curvilinear recess, void, relief, or the like in the body 14 and extends principally in a direction parallel to the longitudinal direction LD. Each aperture 30 begins adjacent the cutting portion 22 and ends in a midsection of the body 14. A first, or starting, end of each aperture 30 is adjacent the cutting portion 22 and a second, or terminating, end of each aperture 30 is in the midsection of the body 14. In the illustrated embodiment, the second end of each aperture 30 is closer than the first end to the attachment portion 18. As best illustrated in FIGS. 2 and 3, the apertures 30 each extend adjacent approximately ten cutting teeth 26 (e.g., approximately two inches along the longitudinal direction LD). The cutting teeth 26 and body 14 adjacent the aperture 30 form a cantilever portion 78 relative to the remainder of the body 14. In another embodiment, the apertures 30 each extend adjacent fewer or more cutting teeth 26. In some embodiments, the apertures 30 may extend different lengths relative to each other.

Each cantilever portion 78 is rigidly supported on the body 14 at a first or base end 82 and extends along the longitudinal direction LD to a second or free end 86. The base end 82 is closer than the free end 86 to the attachment portion 18. As shown in FIG. 2, a height h of the cantilever portion 78 at the base end 82, measured in the transverse direction TD from the plane A-A, decreases along the longitudinal direction LD to the free end 86. The cantilever portion 78 thereby tapers from the base end 82 to the free end 86. The cantilever portion 78 may move (e.g., deflect, deform, compress, etc.) generally along the transverse direction TD relative to the remainder of the body 14 such that the cutting teeth 26 positioned on the cantilever portion 78 no longer align with the plane A-A, thereby defining an offset plane B-B (FIG. 3). In the illustrated embodiment, the aperture 30 continues generally in the transverse direction TD from the gullet 74 of one cutting tooth 26, extends substantially along the longitudinal direction LD, and terminates within the body 14 adjacent the cutting tooth 26 spaced ten cutting teeth away to thereby create the cantilever portion 78.

During a cutting operation of the cutting blade 10 in which the workpiece 88 is a single material (e.g., wood) throughout, the aperture 30) may maintain a consistent thickness t while the cutting teeth 26 positioned on the cantilever portion 78 remain aligned with the plane A-A. Once the cutting blade 10 contacts a relatively hard or rigid object 90, such as a nail within the wood, the cutting teeth 26 positioned on the cantilever portion 78 may deflect as described above to thereby reduce the possibility of damaging the cutting teeth 26 and/or cutting blade 10. In particular, deflecting the cutting teeth 26 helps protect the carbide inserts 76. The cantilever portion 78 may undergo elastic deformation such that cutting teeth 26 positioned on the cantilever portion 78 may return to being aligned with the plane A-A after cutting teeth 26 passes the rigid object 90.

More specifically, the tips 58 of the cutting teeth 26 on the cantilever portion 78 may deflect with the cantilever portion 78 generally in the transverse direction TD at the rake angle RB to temporarily align with the offset plane B-B. During such deflection, as shown in FIG. 3, the thickness t of the aperture 30 adjacent the free end 86 of the cantilever portion 78 may be reduced relative the thickness t adjacent the base end 82. In some scenarios, the thickness t may be fully reduced such that the cantilever portion 78 contacts the body 14 adjacent the free end 86. The cantilever portion 78 may also deflect side-to-side in a direction perpendicular to the transverse direction TD. Once the rigid object 90 has been cleared from the cutting operation, the thickness t is restored to the aperture 30.

By allowing the cutting teeth 26 and tips 58 positioned on the cantilever portion 78 to deflect at the rake angle RB, the lasting or usability of the cutting blade 10 may be increased. It should be noted that a shape, size, profile, or the like of the aperture 30, and therefore the cantilever portion 78, may affect an amount the thickness t changes during deflection. Although the thickness t may be consistent throughout the aperture 30 when the cantilever portion 78 is not deflected (FIGS. 1-4), an amount the thickness t changes when the cantilever portion 78 is deflected may not be uniform when measured relative the longitudinal or transverse directions LD, TD.

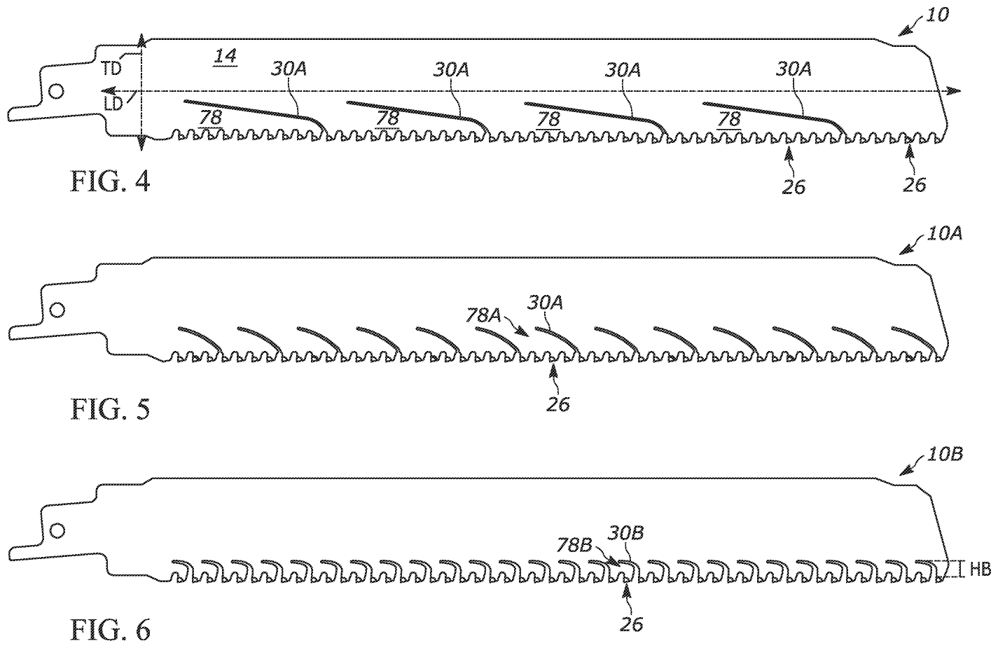

As illustrated in FIG. 4, the cutting blade 10 may include four apertures 30 formed in the body 14 of the cutting blade 10, thereby forming four cantilever portions 78. Stated another way, the cutting blade 10 illustrated in FIG. 4 may be constructed to include an aperture 30 and cantilever portion 78 about every ten cutting teeth 26.

FIGS. 5-11 illustrate similar saw blades as FIG. 4 with different aperture configurations. Some example differences between the apertures 30 and the cantilever portions 78 are described below. Variations of the apertures and cantilever portions not specifically discussed or illustrated are also contemplated. In addition, variations of the apertures and cantilever portions described with reference to one example construction are not necessarily limited to that example construction. Stated another way, apertures and cantilever portions from the different example constructions described herein could be included on a single saw blade.

As illustrated in FIG. 5, a cutting blade 10A includes apertures 30A and cantilever portions 78A that are relatively shorter compared to the cutting blade 10 shown in FIG. 4. The cutting blade 10A includes an aperture 30A and a cantilever portion 78A for every about four cutting teeth 26. As such, the cutting blade 10A illustrated in FIG. 5 includes thirteen apertures 30A. The cantilever portions 78A corresponding to a fewer number of cutting teeth 26 may increase the rigidity of the cantilever portions 78A and increase the amount of force (e.g., strength of foreign or rigid object 90) needed to cause the cantilever portions 78A to deflect.

Similarly, as shown in FIG. 6, a cutting blade 10B may include an aperture 30B and a cantilever portion 78B for every about two cutting teeth 26, or even, for example, every one cutting tooth 26. As such, the cutting blade 10B illustrated in FIG. 6 includes twenty-six apertures 30B. Additionally, a height HB of each aperture 30B in the transverse direction TD may be altered relative an adjacent aperture 30B and/or the apertures according to other embodiments.

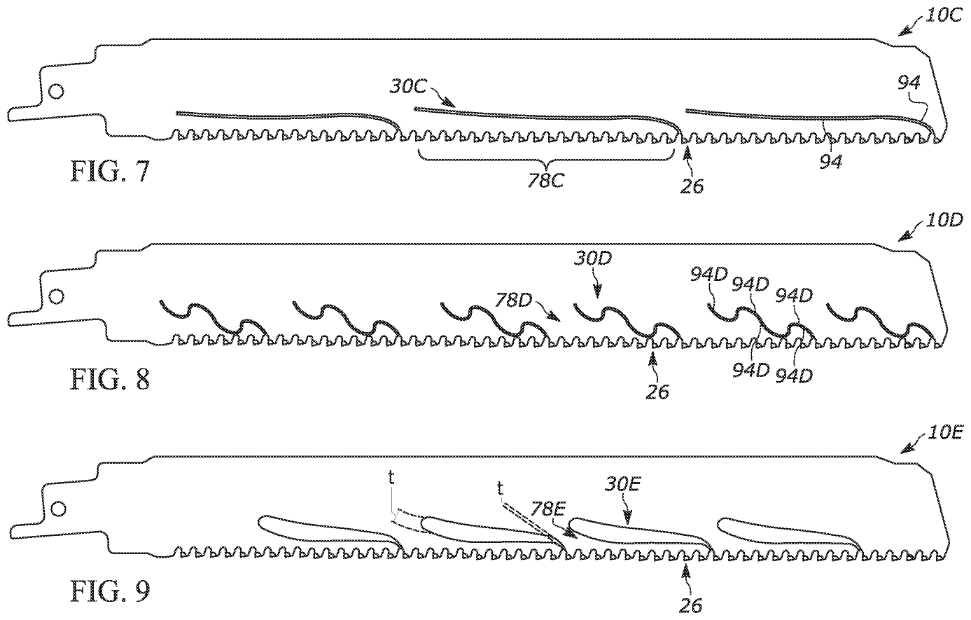

Alternatively, as shown in FIG. 7, a cutting blade 10C includes apertures 30C and cantilever portions 78C that are relatively longer compared to the cutting blade 10 shown in FIG. 4. The cutting blade 10C illustrated in FIG. 7 includes, according to one example construction, an aperture 30C and a cantilever portion 78C for every about fifteen to twenty cutting teeth 26. In such construction, the cantilever portions 78C corresponding to a greater number of cutting teeth 26 may decrease the rigidity of the cantilever portions 78C and decrease the amount of force (e.g., strength of foreign or rigid object 90) needed to cause the cantilever portion 78C to deflect. As further shown in FIG. 7, the apertures 30C may be undulated to provide a different profile of deflection for the cantilever portions 78C. According to the example construction illustrated in FIG. 7, the apertures 30C include two alternating undulations 94. In this manner, the cantilever portions 78C share the two alternating undulations 94 in a complementary or opposite sense.

As shown in FIG. 8, another example construction of a cutting blade 10D includes an aperture 30D and a cantilever portion 78D for every about ten cutting teeth 26. Each aperture 30D and cantilever portion 78D may similarly include alternating and opposing or complimentary undulations 94D. As illustrated in FIG. 8, at least some of the apertures 30D and cantilever portions 78D each include about five undulations 94D, giving the apertures 30D wave-like profiles. As also illustrated in FIG. 8, one or more of the apertures 30D and cantilever portions 78D may include fewer than about five undulations (i.e., four undulations).

Referring now to FIG. 9, another example construction of a cutting blade 10E includes an aperture 30E and a cantilever portion 78E for every about eight to ten cutting teeth 26. Each of the apertures 30E and cantilever portions 78E may still have a generally undulated profile. As shown in FIG. 9, when the cantilever portion 78E is not in a deflected state, the aperture 30E has a varying thickness t rather than a substantially uniform thickness. Accordingly, during deflection of the cantilever portion 78E, the thickness t may not only have a different value at different positions along the aperture 30E, but may also deflect or change by different amounts at different positions along the aperture 30E.

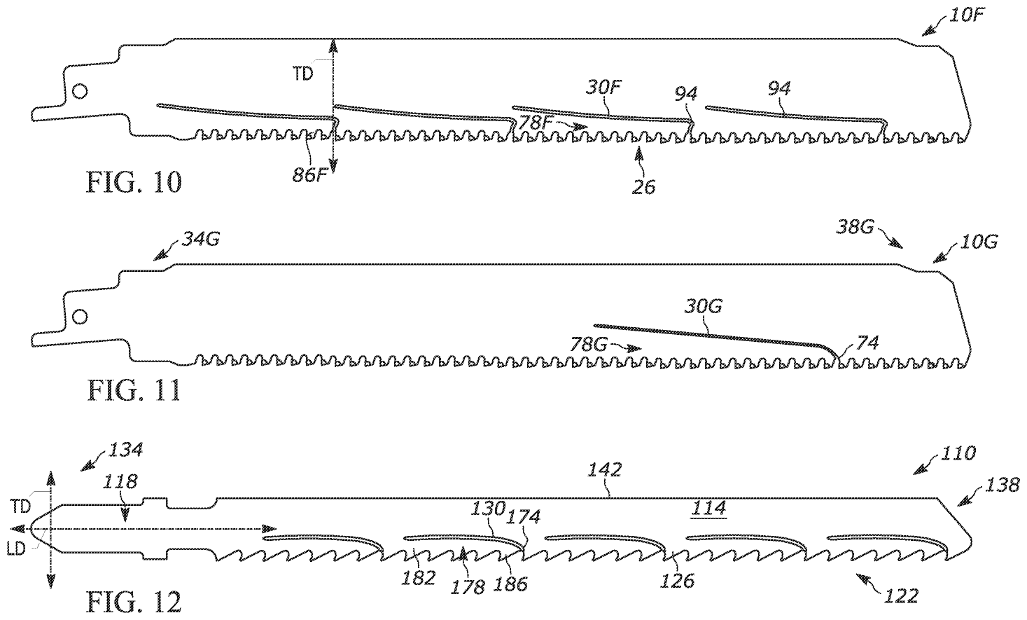

With reference to FIG. 10, another example construction of a cutting blade 10F includes an aperture 30F and a cantilever portion 78F for every about ten to fifteen cutting teeth 26. Each of the apertures 30F and cantilever portions 78F may still have a generally undulated profile, and as shown in FIG. 10, such undulated profile may include acutely angled undulations 94 and/or larger (e.g., elongated) undulations 94. As further shown in FIG. 10, a free end 86F of one of the cantilever portions 78F may, in some examples, overlap an end of an adjacent apertures 30F relative the transverse direction TD. In other words, two adjacent apertures 30F may overlap one another relative the transverse direction TD.

With reference to FIG. 11, another example construction of a cutting blade 10G includes a single aperture 30G and a single corresponding cantilever portion 78G. Although illustrated as being positioned closer to a second end 38G of the cutting blade 10G than to a first end 34G of the cutting blade 10G, the single aperture 30G and corresponding cantilever portion 78G could be positioned generally closer to the first end portion 34 or generally in the middle of the cutting blade 10G. Additionally, any of the apertures described above with respect to FIGS. 5-11 (i.e., 30 . . . 30G) could extend from the gullet 74 of the first cutting tooth 26 (e.g., the cutting tooth 26 closest to either end portion 34, 38) or even from a front, top, bottom, etc. face or surface of the cutting blade 10.

FIG. 12 illustrates a cutting blade 110 according to another embodiment. The cutting blade 110 of FIG. 12 is similar to the cutting blade 10 described above with reference to FIGS. 1-4, and similar features are identified with similar reference numbers, plus “100.” Some differences between the cutting blade 10 and the cutting blade 110 are briefly described.

Referring to FIG. 12, the cutting blade 110 is a jigsaw blade for use with a power tool such as, for example, a jigsaw: The cutting blade 110 includes a body 114, an attachment portion 118 for coupling the cutting blade 110 to the jigsaw, a cutting portion 122 having a plurality of cutting teeth 126, one or more apertures 130, and one or more corresponding cantilever portions 178 formed in the body 114. The body 114 of the cutting blade 110 includes a first end portion 134 and a second end portion 138 separated from the first end portion 134 along a longitudinal or cutting direction LD. The body 114 further defines a transverse direction TD generally transverse the longitudinal direction LD. The body 114 may further include a back edge 142 separated from the cutting portion 122 along the transverse direction TD, and the back edge 142 may be relatively linear.

One or more of the apertures 130 may be elongated and formed in the body 114. The cutting teeth 126 and body 114 adjacent each aperture 130 form the cantilever portion 178. In some constructions, the apertures 130 may extend from one or more gullets 174 formed between portions of adjacent cutting teeth 126 (e.g., the gullet 174 may separate adjacent cutting teeth 126). The cantilever portion 178 is rigidly supported on the body 114 at a first or base end 182 and extends along the longitudinal direction LD to a free or second end 186. As described above with reference to FIGS. 1-11, at least a portion of the cantilever portion 178 (e.g., the free end 186) may elastically deflect, deform, compress, etc. generally along the transverse direction TD during a cutting operation through a foreign object, such as a nail. Stated another way, the cantilever portions 178 are configured to deform at least partially into the void formed by the apertures 130 to absorb a shock to the cutting teeth 126 generated by the nail. Allowing the cantilever portions 178 to flex, in some instances, improves the useable longevity of the cutting teeth 126 and thus the cutting blade 110.

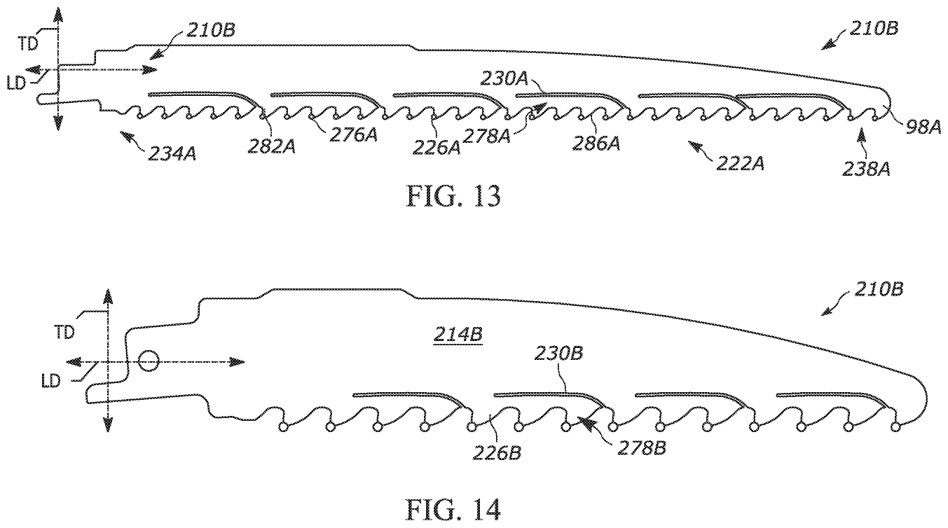

FIGS. 13-15 illustrate example constructions of cutting blades 210A, 210B, 210C according to other embodiments. The cutting blades 210A, 210B, 210C of FIGS. 13-15 are similar to the cutting blade 10 described above with reference to FIGS. 1-4, and similar features are identified with similar reference numbers, plus “200.” Some differences between the cutting blade 10 and the cutting blades 210A, 210B, 210C are briefly described.

Referring to FIG. 13, the cutting blade 210A is a reciprocating saw blade 210A for use with a power tool such as, for example, the reciprocating saw 100. The saw blade 210A includes a body 214A, an attachment portion 218A for coupling the saw blade 210A to the reciprocating saw 100, a cutting portion 222A having a plurality of cutting teeth 226A, one or more apertures 230A, and one or more corresponding cantilever portions 278A formed in the body 214A. The body 214A of the saw blade 210A includes a first end portion 234A and a second end portion 238A separated from the first end portion 234A along a longitudinal or cutting direction LD. The body 214A further defines a transverse direction TD generally transverse the longitudinal direction LD. The body 214A may further include a back edge 242A separated from the cutting portion 222A along the transverse direction TD, and the back edge 242A may be relatively elongated and/or curvilinear. The second end portion 238A of the body 214A may be a plunge tip 98A configured for initiating a cutting operation of the saw blade 210A into a workpiece. Each of the cutting teeth 226A may also include a carbide insert 276A.

One or more of the apertures 230A may be elongated and formed in the body 214A. The cutting teeth 226A and body 214A adjacent the aperture 230A form the cantilever portion 278A. In some constructions, the apertures 230A may extend from one or more gullets 274A formed between portions of adjacent cutting teeth 226A (e.g., the gullet 274A may separate adjacent cutting teeth 226A). The cantilever portion 278A is rigidly supported on the body 214A at a first or base end 282A and extends along the longitudinal direction LD to a second or free end 286A. As described above with reference to FIGS. 1-11, at least a portion of the cantilever portion 278A (e.g., the free end 286A) may elastically deflect, deform, compress, etc. generally along the transverse direction TD during a cutting operation through a foreign object, such as a nail. Stated another way, the cantilever portions 278A are configured to deform at least partially into the void formed by the apertures 230A to absorb a shock to the cutting teeth 226A generated by the nail. Allowing the cantilever portions 278A to flex, in some instances, improves the useable longevity of the cutting teeth 226A and thus the cutting blade 210A.

As illustrated in FIG. 13, the saw blade 210A may include six apertures 230A formed in the blade body 214A, thereby forming six cantilever portions 278A. Stated another way, the saw blade 210A illustrated in FIG. 13 may be constructed to include an aperture 230A and cantilever portion 278A every about five cutting teeth 226A.

As shown in FIG. 14, another example construction of the saw blade 210B includes a blade body 214B having four apertures 230B formed therein, thereby forming four cantilever portions 278B. In other words, the example saw blade 210B illustrated in FIG. 14 may be constructed to include an aperture 230B and cantilever portion 278B every about two or three cutting teeth 226B.

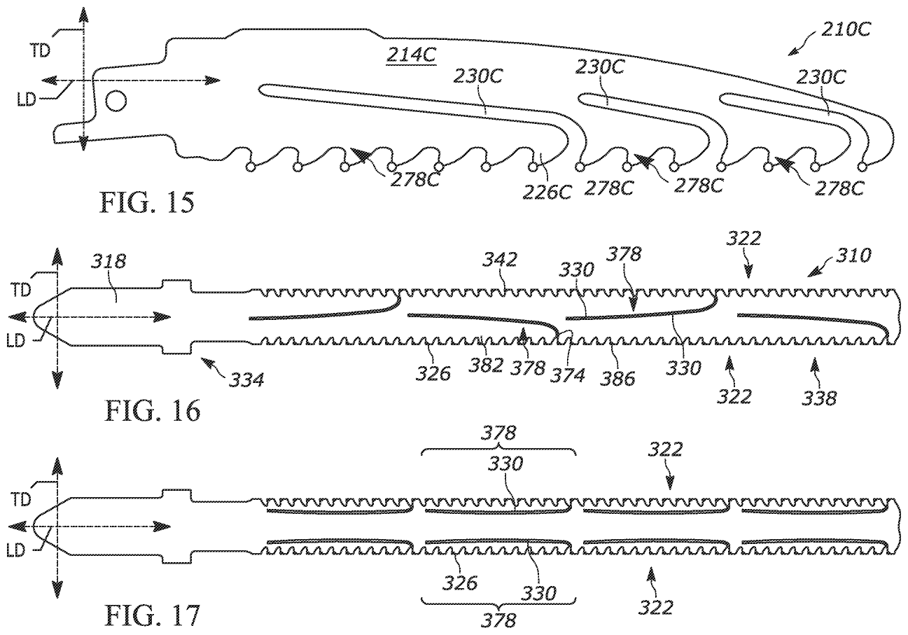

As shown in FIG. 15, another example construction of the saw blade 210C includes a blade body 214C having three apertures 230C formed therein, thereby forming three cantilever portions 278C. As further shown in FIG. 15, the amount of cutting teeth 226C defining each of the cantilever portions 278C may be differed relative one another. For example, the body 214C may include two apertures 230C and cantilever portions 278C every about two or three cutting teeth 226C, and one aperture 230C and cantilever portion 278 spanning adjacent about six to eight cutting teeth 226C.

FIGS. 16 and 17 illustrate example constructions of a cutting blade 310 according to another embodiment. The cutting blade 310 of FIGS. 16 and 17 is similar to the cutting blade 10 described above with reference to FIGS. 1-4, and similar features are identified with similar reference numbers, plus “300.” Some differences between the cutting blade 10 and the cutting blade 310 are briefly described.

Referring to FIGS. 16 and 17, the cutting blade 310 is a jigsaw blade for use with a power tool such as, for example, a jigsaw. The cutting blade 310 includes a body 314, an attachment portion 318 for coupling the cutting blade 310 to the jigsaw, opposing cutting portions 322 each having a plurality of cutting teeth 326, one or more apertures 330, and one or more corresponding cantilever portions 378 formed in the body 314. The body 314 of the cutting blade 310 includes a first end portion 334 and a second end portion 338 separated from the first end portion 334 along a longitudinal or cutting direction LD. The body 314 further defines a transverse direction TD generally transverse the longitudinal direction LD. The opposing cutting portions 322 may oppose one another along the transverse direction TD.

One or more of the apertures 330 may be elongated and formed in the body 314. The cutting teeth 326 and body 314 adjacent the aperture 330 form the cantilever portion 378. In some constructions, the apertures 330 may extend from one or more gullets 374 formed between portions of adjacent cutting teeth 326 (e.g., the gullet 374 may separate adjacent cutting teeth 326). The cantilever portion 378 is rigidly supported on the body 314 at a first or base end 382 and extends along the longitudinal direction LD to a second or free end 386. As described above with reference to FIGS. 1-11, at least a portion of the cantilever portion 378 (e.g., the free end 386) may elastically deflect, deform, compress, etc. generally along the transverse direction TD during a cutting operation through a foreign object, such as a nail. Stated another way, the cantilever portions 378 are configured to deform at least partially into the void formed by the apertures 330 to absorb a shock to the cutting teeth 326 generated by the nail (e.g., rigid object 90). Allowing the cantilever portions 378 to flex, in some instances, improves the useable longevity of the cutting teeth 326 and thus the cutting blade 310.

FIG. 16 illustrates an example construction of the cutting blade 310 in which the opposing cutting portions 322 of the body 314 each include an aperture 330 and a cantilever portion 378 for every about twenty-eight to thirty-two cutting teeth 326 such that the body 314 includes a total of four apertures 330 and cantilever portions 378 (e.g., two per opposing cutting portion 322).

FIG. 17 illustrates another example construction of the cutting blade 310 in which the each of the opposing cutting portions 322 of the body 314 include an aperture 330 and a cantilever portion 378 for every about twelve to sixteen cutting teeth 326 such that the body 314 includes a total of eight apertures 330 and cantilever portions 378 (e.g., four per opposing cutting portion 322).

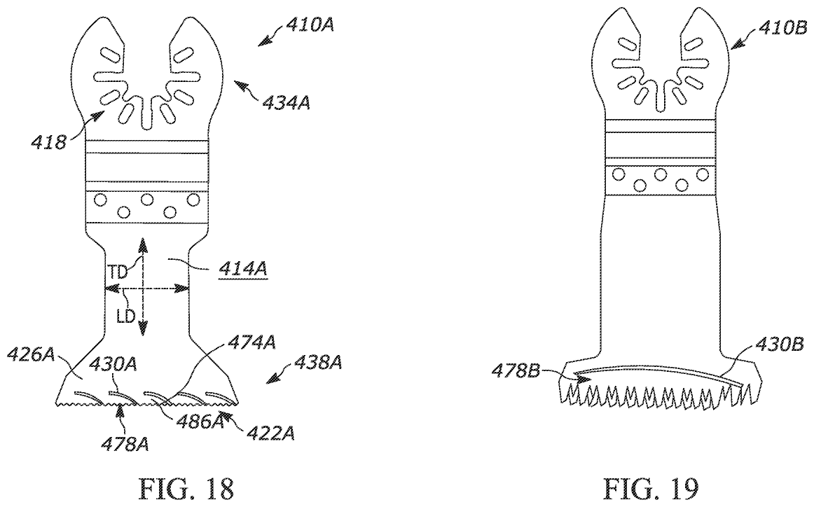

FIGS. 18 and 19 illustrate example constructions of cutting blades 410A, 410B according to another embodiment. The cutting blades 410A, 410B of FIGS. 18 and 19 are similar to the cutting blade 10 described above with reference to FIGS. 1-4, and similar features are identified with similar reference numbers, plus “400.” Some differences between the cutting blade 10 and the cutting blades 410A, 410B are briefly described.

Referring to FIG. 18, the cutting blade 410A is an oscillating multi tool (OMT) cutting blade for use with a power tool such as, for example, an oscillating multi tool 200 (FIG. 21). The cutting blade 410A includes a body 414A, an attachment portion 418A for coupling the cutting blade 410A to the oscillating multi tool 200, a cutting portion 422A having a plurality of cutting teeth 426A, one or more apertures 430A, and one or more corresponding cantilever portions 478A formed in the body 414A. The body 414A of the cutting blade 410A includes a first end portion 434A and a second end portion 438A separated from the first end portion 434A along a transverse direction TD. The body 414A further defines a longitudinal or cutting direction LD along which the plurality of cutting teeth 426A extend. The transverse and longitudinal directions TD, LD are generally transverse relative one another.

One or more of the apertures 430A may be elongated and formed in the body 414A. The cutting teeth 426A and body 414A adjacent the aperture 430A form the cantilever portion 478A. In some constructions, the apertures 430A may extend from one or more gullets 474A formed between portions of adjacent cutting teeth 426A (e.g., the gullet 474A may separate adjacent cutting teeth 426A). The cantilever portion 478A is rigidly supported on the body 414A at a first or base end 482A and extends along the longitudinal direction LD to a second or free end 486A. As similarly described above with reference to FIGS. 1-11, at least a portion of the cantilever portion 478A (e.g., the free end 486A) may elastically deflect, deform, compress, etc. generally along the transverse direction TD during a cutting operation through a foreign object, such as a nail. Stated another way, the cantilever portions 478A are configured to deform at least partially into the void formed by the apertures 430A to absorb a shock to the cutting teeth 426A generated by the nail. Allowing the cantilever portions 478A to flex, in some instances, improves the useable longevity of the cutting teeth 426A and thus the cutting blade 410A.

FIG. 18 illustrates an example construction of the cutting blade 410A in which the body 414A includes an aperture 430A and a cantilever portion 478A for every about four to eight cutting teeth 426A such that the body 414A includes five apertures 430A and cantilever portions 478A.

FIG. 19 illustrates an example construction of the cutting blade 410B in which a body 414B of the cutting blade 410B includes a single aperture 430B and a single cantilever portion 478B. In some example constructions, as illustrated in FIG. 19, the cutting teeth 426B may have a different shape, proportion, pitch angle, or the like relative to the cutting teeth 426B illustrated in FIG. 18, but it should be understood that the shock absorption features discussed herein may be incorporated with a large variety of cutting teeth.

Although particular embodiments embodying independent aspects of the present invention have been shown and described, other alternative embodiments will become apparent to those skilled in the art and are within the intended scope of the independent aspects of the invention. For example, although the above saw blade tooth forms have been described with reference to saw blades for use with reciprocating saws that alternately move the saw blades in cutting directions and return directions, the tooth forms may be used on other types of saw blades having a linear edge, including band saw blades. In addition, the saw blade tooth forms may be used on a non-linear or curved edged saw blade such as a circular saw blade. Furthermore, although described herein with reference to powered cutting tools, the present invention may also be formed on/provided therewith non-powered cutting tool, such as handheld saws. Features discussed with respect to one particular embodiment (e.g., a reciprocating saw blade) may also be used on another embodiment (e.g., a jigsaw blade or an OMT blade).

Various features and advantages of the invention are set forth in the following claims.

What is claimed is:

1. A cutting blade comprising:
a body defining a longitudinal axis;
an attachment portion coupled to the body, the attachment portion configured to be coupled to a power tool; and
a cutting portion extending along an edge of the body parallel to the longitudinal axis, the cutting portion including a plurality of cutting teeth, each cutting tooth including a tip and a rake face extending from the tip, each cutting tooth also including a carbide insert that forms at least the tip of the cutting tooth;
wherein at least part of the cutting portion is deflectable relative to the body.

2. The cutting blade of claim 1, wherein the cutting blade is a reciprocating saw blade.

3. The cutting blade of claim 1, wherein the cutting blade is an oscillating multi tool saw blade.

4. The cutting blade of claim 1, wherein the cutting blade is a jigsaw blade.

5. The cutting blade of claim 1, further comprising an aperture formed in the body to allow the at least part of the cutting portion to deflect relative to the body.

6. The cutting blade of claim 5, wherein the aperture is elongated along the longitudinal axis, wherein the aperture includes a first end and a second end spaced from the first end along the longitudinal axis, and wherein the second end opens to a gullet formed in the cutting portion.

7. The cutting blade of claim 6, wherein the cutting portion includes a cantilever between the first end and the second end, the plurality of cutting teeth including a first plurality of cutting teeth positioned on the cantilever.

8. The cutting blade of claim 7, wherein the first plurality of cutting teeth defines a first plane, and wherein the first plane is configured to be angled relative to the longitudinal axis while the at least part of the cutting portion deflects relative to the body.

9. The cutting blade of claim 8, wherein the aperture is a first aperture, the cutting blade further comprising a plurality of apertures defining a plurality of cantilevers offset from one another along the longitudinal axis.

10. A cutting blade comprising:
a body defining a longitudinal axis;
an attachment portion coupled to the body, the attachment portion configured to be coupled to a power tool;
a plurality of cutting teeth extending from a portion of the body, the plurality of cutting teeth defining a cutting edge of the cutting blade;
an aperture extending in a direction principally parallel to the longitudinal axis, the aperture including a first end adjacent a first cutting tooth and a second end adjacent a second cutting tooth axially offset from the first cutting tooth, the second end being closer than the first end to the attachment portion; and
a cantilever portion formed between the aperture and the cutting edge, extending between the first end and the second end of the aperture, and supporting some of the cutting teeth, the cantilever portion being deflectable in a direction transverse relative to the longitudinal axis.

11. The cutting blade of claim 10, wherein a part of the cantilever portion adjacent the second end of the aperture is configured to deflect by a greater amount than a part of the cantilever portion adjacent the first end of the aperture is.

12. The cutting blade of claim 10, wherein the aperture has a thickness configured to be reduced as the cantilever portion is deflected.

13. The cutting blade of claim 10, wherein at least part of the aperture is curved.

14. The cutting blade of claim 10, further comprising a plurality of the apertures and a plurality of the cantilever portions, the plurality of the cantilever portions offset relative one another along the longitudinal axis.

15. The cutting blade of claim 14, wherein the plurality of the cantilever portions are each separated from adjacent cantilever portions by one or more cutting teeth.

16. The cutting blade of claim 10, wherein each cutting tooth includes a tip, a rake face extending from the tip at a rake angle, a heel face opposite the rake face, and a relief surface extending between the tip and the heel face, and wherein the some of the cutting teeth supported by the cantilever portion are deflectable away from the cutting edge at the rake angle.

17. The cutting blade of claim 16, wherein at least some of the cutting teeth include a carbide insert that forms the tip.

18. The cutting blade of claim 16, wherein adjacent cutting teeth are separated by a gullet, and wherein the first end of the aperture is open to the gullet between the adjacent cutting teeth.

19. A cutting blade comprising:
a body defining a longitudinal axis;
an attachment portion coupled to the body, the attachment portion configured to be coupled to a power tool; and
a cutting portion extending along an edge of the body, the cutting portion including
a first plurality of cutting teeth defining a first plane extending parallel to the longitudinal axis, and
a second plurality of cutting teeth axially offset from the first plurality of cutting teeth and defining a second plane, the second plurality of cutting teeth supported on a cantilever portion and configured to deflect relative to the first plurality of cutting teeth, during which the first plane and the second plane are misaligned,
wherein the cantilever portion has a base end and a free end, and wherein the base end is closer than the free end to the attachment portion.

20. The cutting blade of claim 19, further comprising an aperture formed in the body and separating the cantilever portion from a remainder of the body.
